(19) United States
(12) Patent Application Publication
(10) Pub. No.: US 2024/0205154 A1
(43) Pub. Date: Jun. 20, 2024

(54) DATA TRANSMISSION METHOD AND RELATED DEVICES

(71) Applicant: HUAWEI TECHNOLOGIES CO., LTD., Shenzhen (CN)

(72) Inventors: Bo XU, Shanghai (CN); Kedi WU, Shanghai (CN); Jingwang MA, Shenzhen (CN); Hua CAI, Shanghai (CN)

(21) Appl. No.: 18/589,556

(22) Filed: Feb. 28, 2024

Related U.S. Application Data
(63) Continuation of application No. PCT/CN2022/105143, filed on Jul. 12, 2022.

(30) Foreign Application Priority Data
Aug. 31, 2021 (CN) 202111015716.5

(51) Int. Cl. H04L 47/10; H04L 41/0803

(52) U.S. Cl. CPC H04L 47/10; H04L 41/0803

(57) ABSTRACT

A data transmission method includes receiving, by a network device, a tactile data flow and at least one first data flow sent by a machine-side device. The tactile data flow and the at least one first data flow includes a synchronization identifier. The data transmission method also includes synchronizing, by the network device, transmission time of the tactile data flow and transmission time of the at least one first data flow.

### CROSS-REFERENCE TO RELATED APPLICATIONS

This application is a continuation of International Application No. PCT/CN2022/105143, filed on Jul. 12, 2022, which claims priority to Chinese Patent Application No. 202111015716.5, filed on Aug. 31, 2021. The disclosures of the aforementioned applications are hereby incorporated by reference in their entireties.

### TECHNICAL FIELD

Embodiments of this application relate to the communication field, and in particular, to a data transmission method and related devices.

### BACKGROUND

With popularity of remote operation applications, tactile information becomes important information carried in wireless communication. In addition, because a human body responds to tactile sensation faster, a sampling rate of the tactile information is much higher than a sampling rate of video information and audio information, and is usually at a magnitude of 1000 Hz. Compared with a frame rate of 20 Hz to 120 Hz for the video information, the tactile information is increased to a frame rate of 200 Hz to 1000 Hz. Collected data should be immediately packaged and transmitted to reduce a delay. This imposes great pressure on wireless network transmission.

In an existing tactile information sending technology, different transmission priorities are usually assigned to the tactile information that needs to be immediately packaged and transmitted and other information that does not need to be immediately packaged and transmitted, so that the tactile information that needs to be immediately transmitted is preferentially sent, and the other information that does not need to be immediately transmitted is not preferentially sent. In this way, a requirement of the tactile information for a transmission speed can be met. For example, in an existing 5G network, when receiving a plurality of data flows, a network device may classify the plurality of data flows to correspond to different air interface connection resources based on different data transmission requirements of the data flows, to schedule the air interface resources to meet the different data transmission requirements of the data flows.

In the existing tactile information sending technology, the tactile information and the other information are separately sent. However, if the tactile information has a dependency relationship or an association relationship with the other information, for example, information such as temperature information, audio information, or device status information that has an association relationship with the tactile information, because data transmission is not synchronous, invalid transmission of the tactile information or the other information occurs. For example, the tactile information fails to be transmitted, and the other information cannot be separately decoded. Alternatively, a transmission delay of the other information exceeds a waiting time range of the tactile information. Consequently, the tactile information and the other information that have an association relationship cannot be synchronously and completely transmitted, reducing transmission efficiency.

### SUMMARY

Embodiments of this application provide a data transmission method and related devices, to synchronously transmit tactile information and other types of information, to improve transmission efficiency and improve overall user experience.

A first aspect of this application provides a data transmission method. The method is applied to a data transmission network system. The data transmission network system includes a machine-side device, a network device, and a user-side device. The data transmission method is used to synchronously transmit tactile information and other types of information between the machine-side device, the network device, and the user-side device. The method includes: The network device receives a tactile data flow and at least one first data flow that are sent by the machine-side device, where the tactile data flow includes a synchronization identifier, and each of the at least one first data flow includes the synchronization identifier. The network device synchronizes transmission time of the tactile data flow and transmission time of the at least one first data flow.

In this possible implementation, the network device synchronizes the tactile data flow and the first data flow that have the same synchronization identifier, to synchronize the transmission time and a transmission priority of the tactile data flow and the transmission time and a transmission priority of the at least one first data flow, so that the tactile data flow and the at least one first data flow can be synchronously transmitted, thereby reducing a probability of invalid transmission, improving transmission efficiency, and improving overall user experience.

In a possible implementation of the first aspect, that the network device synchronizes a transmission time interval of the tactile data flow and a transmission time interval of the at least one first data flow includes: The network device determines the transmission time interval of the tactile data flow and the transmission time interval of the at least one first data flow; and the network device synchronizes the transmission time interval of the at least one first data flow and the transmission time interval of the tactile data flow.

In this possible implementation, a method for synchronizing the transmission time interval and the transmission priority of the tactile data flow and the transmission time interval and the transmission priority of the at least one first data flow by the network device is provided, thereby improving implementability of this solution.

In a possible implementation of the first aspect, the tactile data flow and the at least one first data flow are sent by a plurality of machine-side devices, and that the network device synchronizes the transmission time interval of the at least one first data flow and the transmission time interval of the tactile data flow includes: The network device determines the transmission time intervals of the tactile data flow and the at least one first data flow that are sent by the plurality of machine-side devices; and the network device synchronizes the transmission time intervals of the at least one first data flow and the tactile data flow that are sent by the plurality of machine-side devices.

In this possible implementation, a method for synchronizing the transmission time interval and the transmission priority of the tactile data flow and the transmission time interval and the transmission priority of the at least one first data flow by the network device is provided, thereby improving implementability of this solution.

In a possible implementation of the first aspect, before that the network device receives a tactile data flow and at least one first data flow that are sent by the machine-side device, the method further includes: The network device receives data flow parameter information sent by the machine-side device, where the data flow parameter information is parameter information of data flows transmitted between the network device and the machine-side device and between the network device and the user-side device, and the data flow parameter information includes a quality of service coefficient, a synchronization time reference, and a sensor frequency.

In a possible implementation of the first aspect, the method further includes: The network device determines the transmission priority of the tactile data flow and the transmission priority of the at least one first data flow; and the network device synchronizes the transmission priority of the tactile data flow and the transmission priority of the at least one first data flow.

In a possible implementation of the first aspect, that the network device determines the transmission priority of the tactile data flow and the transmission priority of the at least one first data flow includes: The network device determines products of channel quality coefficients and quality of service coefficients that correspond to the tactile data flow and the at least one first data flow as first parameters; and the network device determines ratios of the first parameter to a historical average rate as the transmission priority corresponding to the tactile data flow and the transmission priority corresponding to the at least one first data flow.

In a possible implementation of the first aspect, the method further includes: The network device sends the tactile data flow and the at least one first data flow to the user-side device.

In this possible implementation, the network device further sends the tactile data flow and the at least one first data flow to the user-side device, to implement synchronous transmission of the tactile data flow and the at least one first data flow.

In a possible implementation of the first aspect, the synchronization identifier includes a frame number of a tactile frame corresponding to the tactile data and a common air interface transmission time interval number.

A second aspect of this application provides a data transmission method. The method is applied to a data transmission network system. The data transmission network system includes a machine-side device, a network device, and a user-side device. The data transmission method is used to synchronously transmit tactile information and other types of information between the machine-side device, the network device, and the user-side device. The method includes: The machine-side device obtains a first signal, where the first signal includes tactile data and at least one piece of first data. The machine-side device generates a corresponding tactile data flow and at least one corresponding first data flow based on the first signal, where the tactile data flow includes a synchronization identifier, and each of the at least one first data flow includes the synchronization identifier. The machine-side device sends the tactile data flow and the at least one first data flow to the network device.

In this possible implementation, the network device synchronizes the tactile data flow and the first data flow that have the same synchronization identifier, to synchronize transmission time and a transmission priority of the tactile data flow and transmission time and a transmission priority of the at least one first data flow, so that the tactile data flow and the at least one first data flow can be synchronously transmitted, thereby reducing a probability of invalid transmission, improving transmission efficiency, and improving overall user experience.

In a possible implementation of the second aspect, that the machine-side device generates a corresponding tactile data flow and at least one corresponding first data flow based on the first signal includes: The machine-side device generates the tactile data flow based on the tactile data, where the tactile data flow includes the synchronization identifier; and the machine-side device generates the at least one corresponding first data flow based on the at least one piece of first data, where each of the at least one first data flow includes the synchronization identifier.

In a possible implementation of the second aspect, before that the machine-side device obtains a first signal, the method further includes: The machine-side device sends data flow parameter information to the network device, where the data flow parameter information is parameter information of data flows transmitted between the network device and the machine-side device and between the network device and the user-side device, and the data flow parameter information includes a quality of service coefficient of the data flow, a synchronization time reference, and a sensor frequency.

In this possible implementation, a solution in which the machine-side device processes the first signal is provided, thereby improving implementability of embodiments of this application.

In a possible implementation of the second aspect, the synchronization identifier includes a frame number of a tactile frame corresponding to the tactile data and a common air interface transmission time interval number.

A third aspect of this application provides a network device. The network device has a function of implementing the method in any one of the first aspect or the possible implementations of the first aspect. The function may be implemented by hardware, or may be implemented by hardware by executing corresponding software. The hardware or the software includes one or more modules corresponding to the foregoing function, for example, a determining unit.

A fourth aspect of this application provides a machine-side device. The machine-side device has a function of implementing the method in any one of the second aspect or the possible implementations of the second aspect. The function may be implemented by hardware, or may be implemented by hardware by executing corresponding software. The hardware or the software includes one or more modules corresponding to the foregoing function, for example, an obtaining unit.

A fifth aspect of this application provides a network device. The network device includes at least one processor, a memory, an input/output (I/O) interface, and computer-executable instructions that are stored in the memory and that can be run on the processor. When the computer-executable instructions are executed by the processor, the processor performs the method in any one of the first aspect or the possible implementations of the first aspect.

A sixth aspect of this application provides a machine-side device. The machine-side device includes at least one processor, a memory, an input/output (I/O) interface, and computer-executable instructions that are stored in the memory and that can be run on the processor. When the computer-executable instructions are executed by the processor, the processor performs the method in any one of the second aspect or the possible implementations of the second aspect.

A seventh aspect of this application provides a computer-readable storage medium storing one or more computer-executable instructions. When the computer-executable instructions are executed by a processor, the processor performs the method in any one of the first aspect or the possible implementations of the first aspect.

An eighth aspect of this application provides a computer-readable storage medium storing one or more computer-executable instructions. When the computer-executable instructions are executed by a processor, the processor performs the method in any one of the second aspect or the possible implementations of the second aspect.

A ninth aspect of this application provides a computer program product storing one or more computer-executable instructions. When the computer-executable instructions are executed by a processor, the processor performs the method in any one of the first aspect or the possible implementations of the first aspect.

A tenth aspect of this application provides a computer program product storing one or more computer-executable instructions. When the computer-executable instructions are executed by a processor, the processor performs the method in any one of the second aspect or the possible implementations of the second aspect.

An eleventh aspect of this application provides a chip system. The chip system includes at least one processor, and the at least one processor is configured to implement the function in any one of the first aspect or the possible implementations of the first aspect. In a possible design, the chip system may further include a memory. The memory is configured to store program instructions and data for an apparatus for processing an artificial intelligence model. The chip system may include a chip, or may include a chip and another discrete component.

A twelfth aspect of this application provides a chip system. The chip system includes at least one processor, and the at least one processor is configured to implement the function in any one of the second aspect or the possible implementations of the second aspect. In a possible design, the chip system may further include a memory. The memory is configured to store program instructions and data for an apparatus for data processing based on an artificial intelligence model. The chip system may include a chip, or may include a chip and another discrete component.

Based on the foregoing technical solutions, it can be learned that embodiments of this application have the following advantages:

Embodiments of this application provide the data transmission method. The method is applied to the data transmission network system. The data transmission network system includes the machine-side device, the network device, and the user-side device. The data transmission method is used to synchronously transmit the tactile information and the other types of information between the machine-side device, the network device, and the user-side device. The method includes: The network device receives the tactile data flow and the at least one first data flow that are sent by the machine-side device, where the tactile data flow includes the synchronization identifier, and each of the at least one first data flow includes the synchronization identifier. The network device synchronizes the transmission time and the transmission priority of the tactile data flow and the transmission time and the transmission priority of the at least one first data flow. In this possible implementation, the network device synchronizes the tactile data flow and the first data flow that have the same synchronization identifier, to synchronize the transmission time and the transmission priority of the tactile data flow and the transmission time and the transmission priority of the at least one first data flow, so that the tactile data flow and the at least one first data flow can be synchronously transmitted, thereby reducing the probability of invalid transmission, improving transmission efficiency, and improving overall user experience.

### BRIEF DESCRIPTION OF DRAWINGS

FIG. 1 is a schematic diagram of a scenario of tactile information transmission in accordance with one or more embodiments;

FIG. 2 is a network architecture diagram of a tactile information transmission network according to an embodiment of this application;

FIG. 3 is a schematic flowchart of a data transmission method according to an embodiment of this application;

FIG. 4 is a schematic diagram of a structure of a data flow in a data transmission method according to an embodiment of this application;

FIG. 5 is another schematic flowchart of a data transmission method according to an embodiment of this application;

FIG. 6 is another schematic flowchart of a data transmission method according to an embodiment of this application;

FIG. 7 is another schematic flowchart of a data transmission method according to an embodiment of this application;

FIG. 8 is a schematic diagram of a structure of a network device according to an embodiment of this application;

FIG. 9 is a schematic diagram of a structure of a machine-side device according to an embodiment of this application;

FIG. 10 is another schematic diagram of a structure of a network device according to an embodiment of this application;

FIG. 11 is another schematic diagram of a structure of a machine-side device according to an embodiment of this application; and

FIG. 12 is a schematic diagram of a structure of a tactile information transmission network according to an embodiment of this application.

### DESCRIPTION OF EMBODIMENTS

Embodiments of this application provide a data transmission method and related devices, to synchronously transmit tactile information and other types of information, to improve transmission efficiency and improve overall user experience.

Embodiments of this application are described below with reference to the accompanying drawings. It is clear that, the described embodiments are merely some rather than all of embodiments of this application. A person of ordinary skill in the art may know that with technical development and emergence of a new scenario, the technical solutions provided in embodiments of this application are also applicable to a similar technical problem.

In the specification, the claims, and the accompanying drawings of this application, the terms “first”, “second”, and the like are intended to distinguish between similar objects but do not necessarily indicate a particular order or sequence. It should be understood that data used in this way is interchangeable in appropriate cases so that embodiments of this application described herein can be implemented in other orders other than the order illustrated or described herein. In addition, the terms “include” and “have” and any other variants thereof are intended to cover a non-exclusive inclusion. For example, a process, a method, a system, a product, or a device that includes a list of steps or units is not necessarily limited to those expressly listed steps or units, but may include other steps or units not expressly listed or inherent to such a process, method, product, or device.

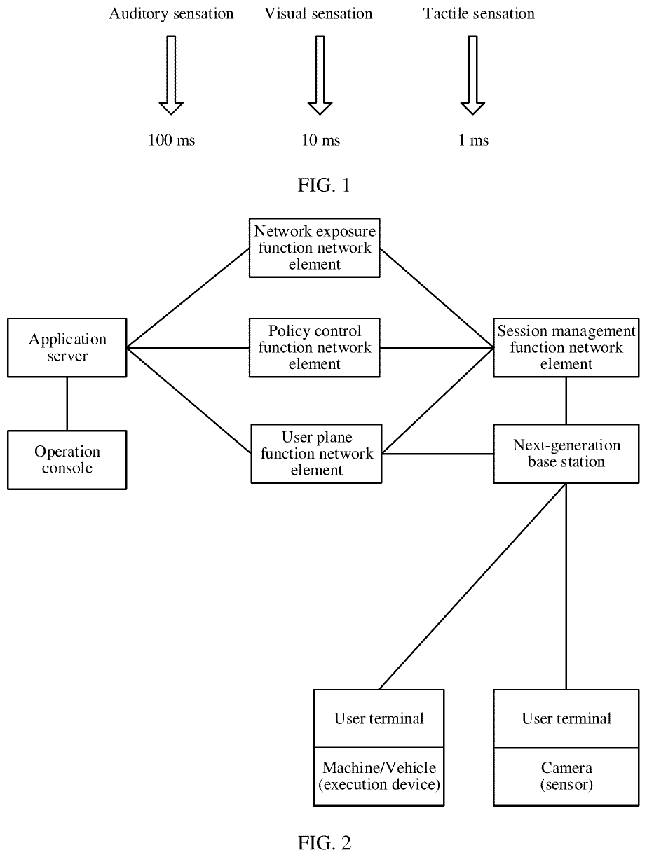

FIG. 1 is a schematic diagram of a scenario of tactile information transmission in accordance with one or more embodiments. With development of remote operation applications, tactile information becomes important information carried in wireless communication. In addition, because a human body responds to tactile sensation faster, a sampling rate of the tactile information is much higher than a sampling rate of video information and audio information, and is usually at a magnitude of 1000 Hz. Compared with a frame rate of 20 Hz to 120 Hz for the video information, the tactile information is increased to a frame rate of 200 Hz to 1000 Hz. Collected data should be immediately packaged and transmitted to reduce a delay. This imposes great pressure on wireless network transmission.

In an existing tactile information sending technology, different transmission priorities are usually assigned to the tactile information that needs to be immediately packaged and transmitted and other information that does not need to be immediately packaged and transmitted, so that the tactile information that needs to be immediately transmitted is preferentially sent, and the other information that does not need to be immediately transmitted is not preferentially sent.

In this way, a requirement of the tactile information for a transmission speed can be met. For example, in an existing 5G network, when receiving a plurality of data flows, a network device may classify the plurality of data flows to correspond to different air interface connection resources based on different data transmission requirements of the data flows, to schedule the air interface resources to meet the different data transmission requirements of the data flows.

In the existing tactile information sending technology, the tactile information and the other information are separately sent. However, if the tactile information has a dependency relationship or an association relationship with the other information, for example, information such as temperature information, audio information, or device status information that has an association relationship with the tactile information, because data transmission is not synchronous, invalid transmission of the tactile information or the other information occurs. For example, the tactile information fails to be transmitted, and the other information cannot be separately decoded.

Alternatively, a transmission delay of the other information exceeds a waiting time range of the tactile information. Consequently, the tactile information and the other information that have an association relationship cannot be synchronously and completely transmitted, reducing transmission efficiency.

Refer to FIG. 2. An embodiment of this application is applied to a tactile information transmission network. The tactile information transmission network includes a user-side device, a network device, and a machine-side device. The user-side device and the machine-side device are separately connected to the network device. This type of network connection may be a wired connection or a wireless connection.

The user-side device may include an application server and a user operation console that have service data flow management and combination functions. The user operation console may transmit information to a network device through the application server. The user-side device may include a feedback device and an operation device. The feedback device may be a display, a speaker, a finger feedback array, and an arm feedback array.

The machine-side device may include a user terminal (UE), an application terminal having a data flow management function and a time synchronization marking function, an execution device, and a sensor.

The network device may include network devices such as a next-generation base station (gNB) having an air interface resource scheduling function, that is, a 5G base station, a session management function (SMF) network element having a session management function, a network exposure function (NEF) network element, a policy control function (PCF) network element, and a user plane function (UPF) network element having a data flow management function and a QoS mapping function.

In embodiments of this application, before data transmission, the user-side device, the network device, and the machine-side device notify devices such as the UPF, the gNB, the UE, and an application terminal of quality of service (QoS) parameters of data flows on which service coding is performed and frame rates of sensors, and synchronize time references. For example, a high-QoS flow may include tactile data, a medium-QoS flow may include audio data and basic video I frame data, and a low-QoS flow may include video enhancement P frame data and other data (maintenance/alarm data and the like). The gNB may be further notified that UE 1 and UE 2 are cooperative terminals. For a synchronization reference, an air interface transmission time interval (TTI) number or a frame number of the tactile data may be used as a timestamp. A frame rate of a tactile signal is 5000 Hz (2 ms), a frame rate of a video signal is 25 Hz (40 ms), and a frame rate of an audio signal is 50 Hz (20 ms).

Based on the foregoing tactile information transmission network, the following describes a data transmission method in embodiments of this application.

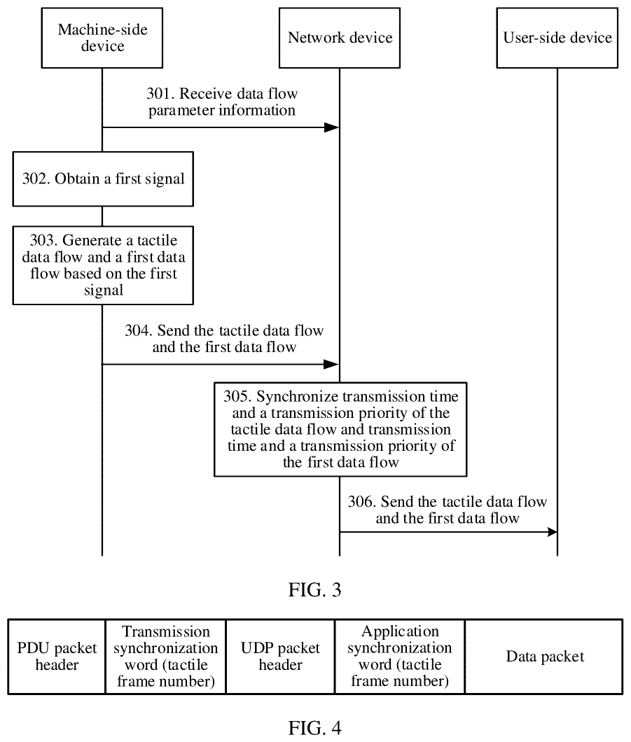

Refer to FIG. 3. An embodiment of this application provides a data transmission method and related devices.

301. A network device receives data flow parameter information.

The network device receives the data flow parameter information sent by a machine-side device, where the data flow parameter information is parameter information of data flows transmitted between the network device and the machine-side device and between the network device and a user-side device. The data flow parameter information includes a quality of service coefficient of the data flow, a synchronization time reference, and a sensor frequency.

Before data transmission, the user-side device, the network device, and the machine-side device notify devices such as a UPF, a gNB, UE, and an application terminal of quality of service (QoS) parameters of data flows on which service coding is performed and frame rates of sensors, and synchronize time references. For example, a high-QoS flow may include tactile data, a medium-QoS flow may include audio data and basic video I frame data, and a low-QoS flow may include video enhancement P frame data and other data (maintenance/alarm data and the like). The gNB may be further notified that UE1 and UE2 are cooperative terminals. For a synchronization reference, an air interface transmission time interval (TTI) number or a frame number of the tactile data may be used as a timestamp. A frame rate of a tactile signal is 5000 Hz (2 ms), a frame rate of a video signal is 25 Hz (40 ms), and a frame rate of an audio signal is 50 Hz (20 ms).

302. The machine-side device obtains a first signal.

The network device receives the first signal sent by the machine-side device, where the first signal may include tactile data and at least one piece of first data. The at least one piece of first data may be data of a plurality of types, for example, audio data, video basic I frame data, video enhancement P frame data, and text data. This is not specifically limited herein.

In a possible implementation, the machine-side device includes a plurality of sensors such as an application terminal, a tactile sensor, a camera, and a microphone. The application terminal obtains the first signal through the plurality of sensors such as the tactile sensor, the camera, and the microphone.

303. The machine-side device generates a tactile data flow and a first data flow based on the first signal.

As shown in FIG. 4, the machine-side device generates the corresponding tactile data flow and the corresponding first data flow based on the first signal, that is, the tactile data and the at least one piece of first data. The machine-side device generates the tactile data flow based on the tactile data, where a packet header of the tactile data flow includes a synchronization identifier. The machine-side device further generates the at least one corresponding first data flow based on the at least one piece of first data, where a packet header of each of the at least one first data flow includes the synchronization identifier. The synchronization identifier may be a frame number of a tactile frame corresponding to the tactile data or a common air interface TTI number.

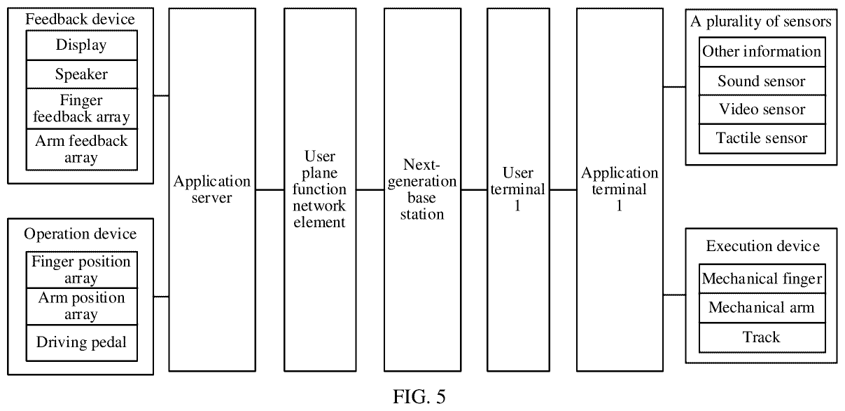

As shown in FIG. 5, in a possible implementation, the machine-side device includes a plurality of sensors such as an application terminal, a tactile sensor, a camera, and a microphone. After the application terminal receives first signals sent by the plurality of sensors such as the tactile sensor, the camera, and the microphone, the application terminal generates a tactile data flow by compressing and encoding the tactile data, generates at least one corresponding first data flow by compressing and encoding the at least one piece of first data, and then adds a frame number of a tactile frame corresponding to the tactile data to a packet header of the tactile data flow and a packet header of the at least one first data flow as an application synchronization word.

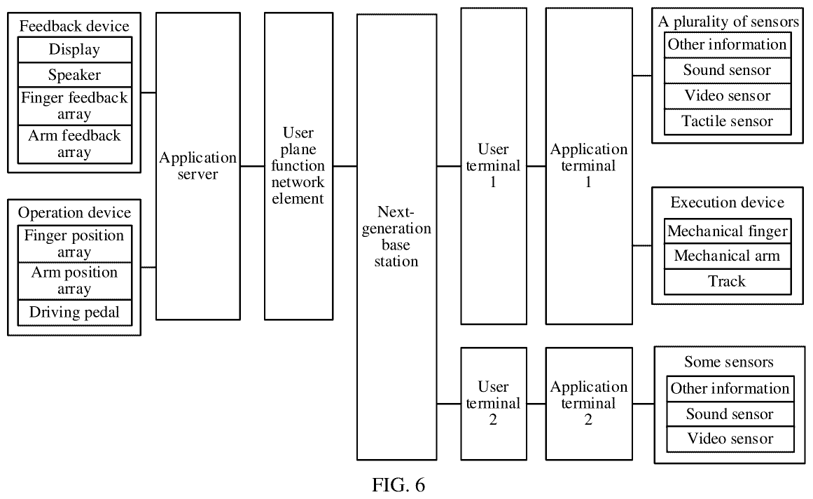

As shown in FIG. 6, in a possible implementation, the machine-side device includes a plurality of application terminals. After the plurality of application terminals receive corresponding tactile data and first data, the plurality of application terminals each generate a tactile data flow by compressing and encoding the tactile data, generate at least one corresponding first data flow by compressing and encoding the at least one piece of first data, and then add a common air interface TTI number to a packet header of the tactile data flow and a packet header of the at least one first data flow as an application synchronization word.

In a possible implementation, the machine-side device further includes a user terminal. After the application terminal generates a tactile data flow and at least one first data flow, the user terminal adds or deletes a transmission synchronization word, that is, a frame number of a tactile frame and frame rate information corresponding to the data flow, to or from a packet header of the tactile data flow and a packet header of the at least one first data flow.

The machine-side device in this embodiment of this application may further transmit other non-tactile application data, and the non-tactile application data has no association relationship with the tactile application data. The non-tactile application data does not include the foregoing synchronization word.

304. The machine-side device sends the tactile data flow and the first data flow to the network device.

The machine-side device sends the tactile data flow and the at least one first data flow to the network device. Correspondingly, the network device receives the tactile data flow and the at least one first data flow that are sent by the machine-side device.

305. The network device synchronizes transmission time and a transmission priority of the tactile data flow and transmission time and a transmission priority of the first data flow.

After the network device receives the tactile data flow and the first data flow, the network device obtains the transmission time and the transmission priority of the tactile data flow and the transmission time and the transmission priority of the first data flow, and synchronizes the transmission time and the transmission priority of the first data flow to be the same as the transmission time and the transmission priority of the tactile data flow.

In a possible implementation, the network device includes a next-generation base station gNB. After the gNB receives the tactile data flow and the first data flow, because the gNB has not established a synchronization relationship with the tactile data flow and the first data flow, the gNB first determines scheduling priorities based on QoS levels of the tactile data flow and the first data flow, to perform resource scheduling.

A method for determining, by the gNB, the scheduling priority of the data flow includes: The scheduling priority P=(E*Y)/A, where P is the scheduling priority of the data flow, E is a channel quality parameter eff_{CQI}, Y is a QoS level coefficient of the data flow, and A is a historical average rate avgRate. In addition, the gNB may further determine the scheduling priority of the data flow in other manners. For example, the gNB directly determines the QoS level as the scheduling priority. This is not specifically limited herein.

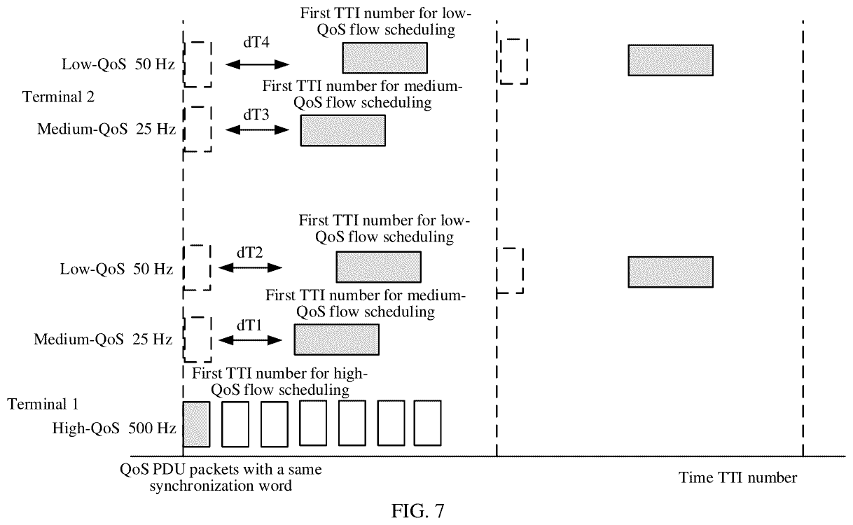

As shown in FIG. 7, in a possible implementation, the network device includes a next-generation base station gNB. After the gNB receives a plurality of data flows, the gNB starts to enter a synchronization training phase: The gNB finds a synchronization identifier, that is, data flows with a same synchronization word, that is, the foregoing tactile data flow and the foregoing first data flow, and then determines a first TTI number of each data flow, where the first TTI number is a TTI number for the first time of air interface scheduling of the data flow; and calculates a difference between first TTIs of each data flow and a high-QoS data flow that are from a same application terminal, that is, dT1, dT2, dT3, and dT4 in FIG. 7.

Then, the gNB enters a synchronization optimization scheduling phase: The gNB continuously calculates dT1, dT2, dT3, and dT4 and separately performs alpha filtering. For example, dT=a*dT+b*dT may be used, where a=0.95, and b=0.05. Synchronous optimization scheduling is more important because signals of tactile/video/audio sensors are collected at a fixed frame rate (that is, a sampling interval), and synchronized information in a plurality of sensors can provide more information for an operator. It can be learned from the training phase that TTI numbers of air interface transmission with synchronization information that may occur are: a high-QoS flow: T, a medium-QoS flow of a terminal 1: T+dT1, a low-QoS flow of the terminal 1: T+dT2, a medium-QoS flow of a terminal 2: T+dT3, and a low-QoS flow of the terminal 2: T+dT4. Then, in an air interface resource scheduler of the gNB, a scheduling priority of a TTI corresponding to each data flow is increased. For example, a scheduling priority P=(E*Y)/A*Ys, where P is a scheduling priority of the data flow, E is a channel quality parameter eff_{CQI}, Y is a QoS level coefficient of the data flow, A is a historical average rate avgRate, Ys is Y_{QoS}, and sync is generally 3.

306. The network device sends the tactile data flow and the first data flow to the user-side device.

The network device sends the tactile data flow and the first data flow to the user-side device. Correspondingly, the user-side device receives the tactile data flow and the first data flow that are sent by the network device.

In a possible implementation, the user-side device includes an application server and a plurality of feedback devices. The application server decodes the tactile data flow and the first data flow after receiving the tactile data flow and the first data flow, aligns signal time of each sensor based on the application synchronization word, and sends the tactile data flow and the first data flow to a corresponding feedback device. The feedback device may be a device such as an arm feedback array, a finger feedback array, a display, or a speaker.

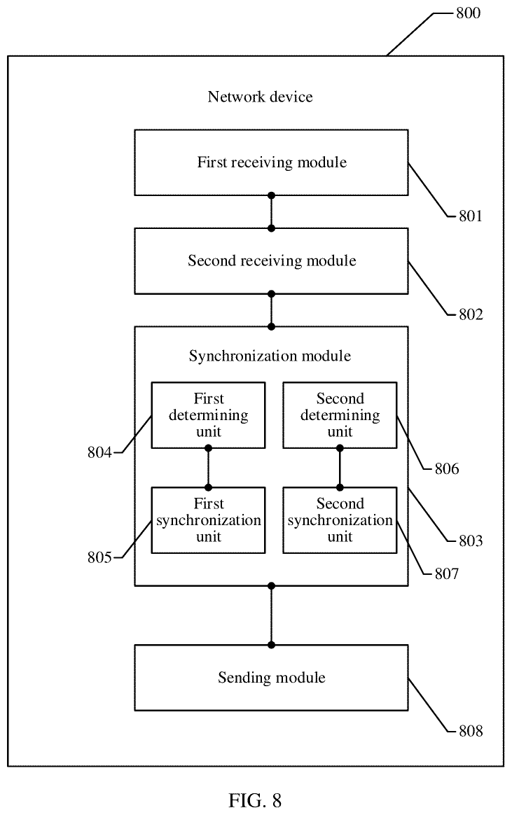

The following describes a network device in embodiments of this application. Refer to FIG. 8. An embodiment of this application provides a network device 800. The network device may be the network device in FIG. 3, and the network device 800 includes the following modules.

A first receiving module 801 is configured to receive data flow parameter information sent by a machine-side device, where the data flow parameter information is parameter information of data flows transmitted between the network device and the machine-side device and between the machine-side device and a user-side device, and the data flow parameter information includes a quality of service coefficient of a data flow, a synchronization time reference, and a sensor frequency. For a specific implementation, refer to step 301 in the embodiment shown in FIG. 3: The network device receives the data flow parameter information sent by the machine-side device. Details are not described herein again.

A second receiving module 802 is configured to receive a tactile data flow and at least one first data flow that are sent by the machine-side device, where the tactile data flow includes a synchronization identifier, and each of the at least one first data flow includes the synchronization identifier. For a specific implementation, refer to step 304 in the embodiment shown in FIG. 3: The machine-side device sends the tactile data flow and the first data flow to the network device. Details are not described herein again.

A synchronization module 803 is configured to synchronize transmission time and a transmission priority of the tactile data flow and transmission time and a transmission priority of the at least one first data flow. For a specific implementation, refer to step 305 in the embodiment shown in FIG. 3: The network device synchronizes the transmission time and the transmission priority of the tactile data flow and the transmission time and the transmission priority of the first data flow. Details are not described herein again.

In a possible implementation, the synchronization module 803 includes the following units.

A first determining unit 804 is configured to determine a transmission time interval of the tactile data flow and a transmission time interval of the at least one first data flow. For a specific implementation, refer to step 305 in the embodiment shown in FIG. 3: The network device synchronizes the transmission time of the tactile data flow and the transmission time of the first data flow. Details are not described herein again.

In a possible implementation, the first determining unit 804 is configured to determine the transmission time intervals of the tactile data flow and the at least one first data flow that are sent by a plurality of machine-side devices. For a specific implementation, refer to step 305 in the embodiment shown in FIG. 3: The network device synchronizes the transmission time of the tactile data flow and the transmission time of the first data flow. Details are not described herein again.

A first synchronization unit 805 is configured to synchronize the transmission time interval of the at least one first data flow and the transmission time interval of the tactile data flow.

For a specific implementation, refer to step 305 in the embodiment shown in FIG. 3: The network device synchronizes the transmission time and the transmission priority of the tactile data flow and the transmission time and the transmission priority of the first data flow. Details are not described herein again.

In a possible implementation, the first synchronization unit 805 is configured to synchronize the transmission time intervals of the at least one first data flow and the tactile data flow that are sent by the plurality of machine-side devices. For a specific implementation, refer to step 305 in the embodiment shown in FIG. 3: The network device synchronizes the transmission time and the transmission priority of the tactile data flow and the transmission time and the transmission priority of the first data flow. Details are not described herein again.

A second determining unit 806 is configured to determine the transmission priority of the tactile data flow and the transmission priority of the at least one first data flow. Refer to step 305 in the embodiment shown in FIG. 3: The network device synchronizes the transmission time and the transmission priority of the tactile data flow and the transmission time and the transmission priority of the first data flow. Details are not described herein again.

In a possible implementation, the second determining unit 806 is configured to determine products of channel quality coefficients and quality of service coefficients that correspond to the tactile data flow and the at least one first data flow as first parameters; and determine ratios of the first parameters to a historical average rate as the transmission priority corresponding to the tactile data flow and the transmission priority corresponding to the at least one first data flow. For a specific implementation, refer to step 305 in the embodiment shown in FIG. 3: The network device synchronizes the transmission time and the transmission priority of the tactile data flow and the transmission time and the transmission priority of the first data flow. Details are not described herein again.

A second synchronization unit 807 is configured to synchronize the transmission priority of the tactile data flow and the transmission priority of the at least one first data flow. Refer to step 305 in the embodiment shown in FIG. 3: The network device synchronizes the transmission time and the transmission priority of the tactile data flow and the transmission time and the transmission priority of the first data flow. Details are not described herein again.

A sending module 808 is configured to send the tactile data flow and the at least one first data flow to the user-side device. For a specific implementation, refer to step 306 in the embodiment shown in FIG. 3: The network device sends the tactile data flow and the first data flow to the user-side device. Details are not described herein again.

In this embodiment, the network device may perform an operation performed by the network device in any embodiment shown in FIG. 3. Details are not described herein again.

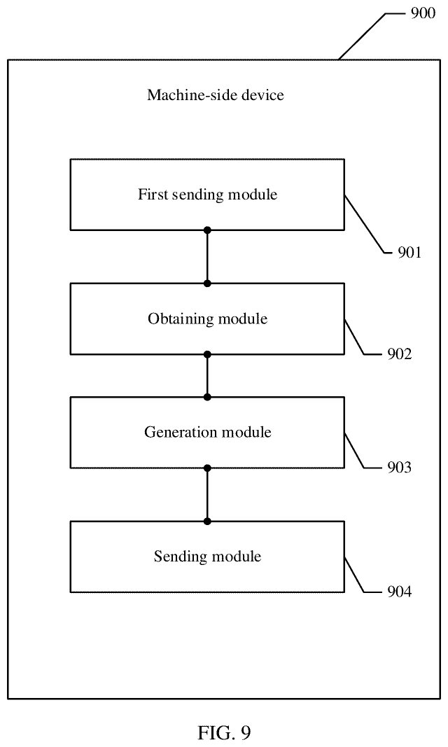

The following describes a machine-side device in embodiments of this application. Refer to FIG. 9. An embodiment of this application provides a machine-side device 900. The machine-side device may be the machine-side device in FIG. 3, and the machine-side device 900 includes the following modules.

A first sending module 901 is configured to send data flow parameter information to a network device, where the data flow parameter information is parameter information of data flows transmitted between the network device and a machine-side device and between the network device and a user-side device, and the data flow parameter information includes a quality of service coefficient of the data flow, a synchronization time reference, and a sensor frequency.

An obtaining module 902 is configured to obtain a first signal, where the first signal includes tactile data and at least one piece of first data. For a specific implementation, refer to step 302 in the embodiment shown in FIG. 3: The machine-side device obtains the first signal. Details are not described herein again.

A generation module 903 is configured to generate a corresponding tactile data flow and at least one corresponding first data flow based on the first signal, where the tactile data flow includes a synchronization identifier, and each of the at least one first data flow includes the synchronization identifier. For a specific implementation, refer to step 303 in the embodiment shown in FIG. 3: The machine-side device generates the tactile data flow and the first data flow based on the first signal. Details are not described herein again.

In a possible implementation, the generation module 903 is configured to generate the tactile data flow based on the tactile data, where the tactile data flow includes the synchronization identifier; and generate the at least one corresponding first data flow based on the at least one piece of first data, where each of the at least one first data flow includes the synchronization identifier. For a specific implementation, refer to step 303 in the embodiment shown in FIG. 3: The machine-side device generates the tactile data flow and the first data flow based on the first signal. Details are not described herein again.

A sending module 904 is configured to send a tactile data flow and at least one first data flow to the network device. For a specific implementation, refer to step 304 in the embodiment shown in FIG. 3: The machine-side device sends the tactile data flow and the first data flow to the network device. Details are not described herein again.

In this embodiment, the machine-side device may perform an operation performed by the controller in any embodiment shown in FIG. 3. Details are not described herein again.

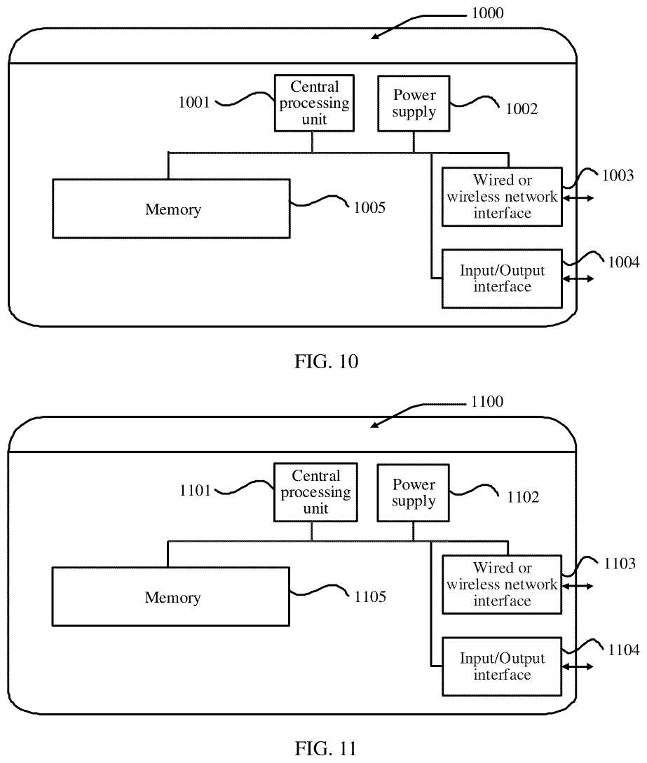

FIG. 10 is a schematic diagram of a structure of a network device according to an embodiment of this application. The network device 1000 may include one or more central processing units (CPU) 1001 and a memory 1005. The memory 1005 stores one or more application programs or data.

The memory 1005 may be a volatile memory or a persistent memory. The program stored in the memory 1005 may include one or more modules, and each module may include a series of instruction operations for the network device. Further, the central processing unit 1001 may be configured to communicate with the memory 1005, and execute, on the network device 1000, the series of instruction operations in the memory 1005.

The central processing unit 1001 is configured to execute a computer program in the memory 1005, to enable the network device 1000 to receive, by the network device, a tactile data flow and at least one first data flow that are sent by a machine-side device, where the tactile data flow includes a synchronization identifier, and each of the at least one first data flow includes the synchronization identifier; and synchronize, by the network device, transmission time and a transmission priority of the tactile data flow and transmission time and a transmission priority of the at least one first data flow. For a specific implementation, refer to steps 301 to 306 in the embodiment shown in FIG. 3. Details are not described herein again.

The network device 1000 may further include one or more power supplies 1002, one or more wired or wireless network interfaces 1003, one or more input/output interfaces 1004, and/or one or more operating systems such as Windows Server™, Mac OS X™, Unix™, Linux™, and FreeBSD™.

The network device 1000 may perform an operation performed by the network device in the embodiment shown in FIG. 3. Details are not described herein again.

FIG. 11 is a schematic diagram of a structure of a machine-side device according to an embodiment of this application. The machine-side device 1100 may include one or more central processing units (CPU) 1101 and a memory 1105. The memory 1105 stores one or more application programs or data.

The memory 1105 may be a volatile memory or a persistent memory. The program stored in the memory 1105 may include one or more modules, and each module may include a series of instruction operations for the machine-side device. Further, the central processing unit 1101 may be configured to communicate with the memory 1105, and execute, on the machine-side device 1100, the series of instruction operations in the memory 1105.

The central processing unit 1101 is configured to execute the computer programs in the memory 1105, to enable the machine-side device 1100 to: obtain, by the machine-side device, a first signal, where the first signal includes tactile data and at least one first data flow; generate, by the machine-side device, a corresponding tactile data flow and at least one corresponding first data flow based on the first signal, where the tactile data flow includes a synchronization identifier, and each of the at least one first data flow includes the synchronization identifier; and send, by the machine-side device, the tactile data flow and the at least one first data flow to the network device. For a specific implementation, refer to steps 301 to 306 in the embodiment shown in FIG. 3. Details are not described herein again.

The machine-side device 1100 may further include one or more power supplies 1102, one or more wired or wireless network interfaces 1103, one or more input/output interfaces 1104, and/or one or more operating systems such as Windows Server™, Mac OS X™, Unix™, Linux™, and FreeBSD™.

The machine-side device 1100 may perform an operation performed by the machine-side device in the embodiment shown in FIG. 3. Details are not described herein again.

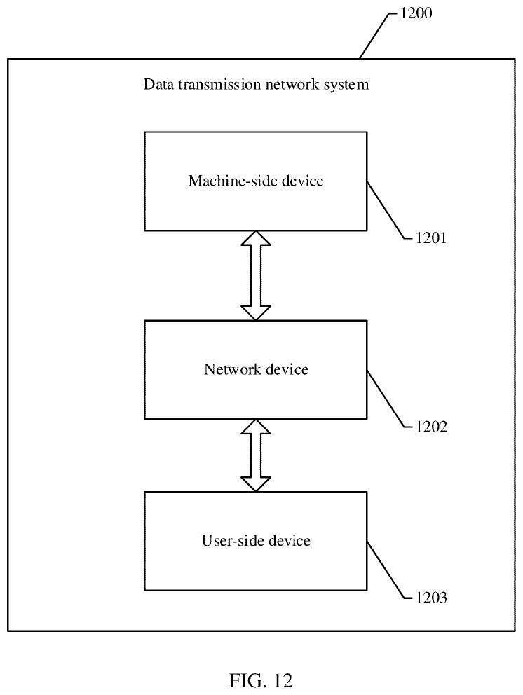

FIG. 12 is a data transmission network system 1200 according to an embodiment of this application. The data transmission network system 1200 may include the machine-side device 1201 shown in FIG. 9, the network device 1202 shown in FIG. 8, and the user-side device 1203. The data transmission network system 1200 may perform operations performed by the data transmission network system in the embodiment shown in FIG. 3. Details are not described herein again.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the apparatus embodiments described above are merely examples. For example, a division of the units is merely a logical function division. During actual implementation, there may be other division methods. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located at one position, or may be distributed on a plurality of network units. Some or all of the units may be selected based on actual requirements to achieve the objectives of the solutions of the embodiments.

In addition, functional units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in a form of a software product. The computer software product is stored in a storage medium and includes several instructions for instructing a computer device (which may be a personal computer, a server, a network device, or the like) to perform all or some of the steps of the methods in embodiments of this application. The foregoing storage medium includes any medium that can store program code, such as a USB flash drive, a removable hard disk, a read-only memory (ROM), a random access memory (RAM), a magnetic disk, or an optical disc.

What is claimed is:

1. A data transmission method, comprising:
receiving, by a network device, a tactile data flow and at least one first data flow sent by a machine-side device, wherein the tactile data flow and the at least one first data flow comprise a synchronization identifier; and
synchronizing, by the network device, transmission time of the tactile data flow and transmission time of the at least one first data flow.

2. The data transmission method according to claim 1, wherein the synchronizing the transmission time of the tactile data flow and the transmission time of the at least one first data flow comprises:
determining, by the network device, a transmission time interval of the tactile data flow and a transmission time interval of the at least one first data flow; and
synchronizing, by the network device, the transmission time interval of the at least one first data flow and the transmission time interval of the tactile data flow.

3. The data transmission method according to claim 2, wherein the tactile data flow and the at least one first data flow are sent by a plurality of machine-side devices, and the synchronizing, by the network device, the transmission time interval of the at least one first data flow and the transmission time interval of the tactile data flow comprises:
determining, by the network device, the transmission time intervals of the tactile data flow and the at least one first data flow sent by the plurality of machine-side devices; and
synchronizing, by the network device, the transmission time intervals of the at least one first data flow and the tactile data flow sent by the plurality of machine-side devices.

4. The data transmission method according to claim 1, wherein before the receiving, by the network device, the tactile data flow and the at least one first data flow sent by the machine-side device, the method further comprises:
receiving, by the network device, data flow parameter information sent by the machine-side device, wherein the data flow parameter information is parameter information of data flows transmitted between the network device and the machine-side device and between the network device and a user-side device, and the data flow parameter information comprises a quality of service coefficient, a synchronization time reference, and a sensor frequency.

5. The data transmission method according to claim 4, further comprising:
determining, by the network device, a transmission priority of the tactile data flow and a transmission priority of the at least one first data flow; and
synchronizing, by the network device, the transmission priority of the tactile data flow and the transmission priority of the at least one first data flow.

6. The data transmission method according to claim 5, wherein the determining, by the network device, the transmission priority of the tactile data flow and the transmission priority of the at least one first data flow comprises:
determining, by the network device, products of channel quality coefficients and quality of service coefficients that correspond to the tactile data flow and the at least one first data flow as first parameters; and
determining, by the network device, ratios of the first parameters to a historical average rate as the transmission priority corresponding to the tactile data flow and the transmission priority corresponding to the at least one first data flow.

7. The data transmission method according to claim 6, further comprising:
sending, by the network device, the tactile data flow and the at least one first data flow to the user-side device.

8. The data transmission method according to claim 1, wherein the synchronization identifier comprises a frame number of a tactile frame corresponding to tactile data and a common air interface transmission time interval number.

9. A network device comprising:
at least one processor; and
one or more memories including computer instructions that, when executed by the at least one processor, cause the network device to:
receive a tactile data flow and at least one first data flow sent by a machine-side device, wherein the tactile data flow and the at least one first data flow comprise a synchronization identifier; and
synchronize transmission time of the tactile data flow and transmission time of the at least one first data flow.

10. The network device according to claim 9, wherein to synchronize the transmission time of the tactile data flow and the transmission time of the at least one first data flow, the network device is caused to:
determine a transmission time interval of the tactile data flow and the transmission time interval of the at least one first data flow; and
synchronize the transmission time interval of the at least one first data flow and the transmission time interval of the tactile data flow.

11. The network device according to claim 10, wherein the tactile data flow and the at least one first data flow are sent by a plurality of machine-side devices, and to synchronize the transmission time interval of the at least one first data flow and the transmission time interval of the tactile data flow, the network device is caused to:
determine the transmission time intervals of the tactile data flow and the at least one first data flow sent by the plurality of machine-side devices; and
synchronize the transmission time intervals of the at least one first data flow and the tactile data flow sent by the plurality of machine-side devices.

12. The network device according to claim 9, wherein the network device is further caused to:
before receiving the tactile data flow and the at least one first data flow sent by the machine-side device, receive data flow parameter information sent by the machine-side device, wherein the data flow parameter information is parameter information of data flows transmitted between the network device and the machine-side device and between the network device and a user-side device, and the data flow parameter information comprises a quality of service coefficient, a synchronization time reference, and a sensor frequency.

13. The network device according to claim 12, wherein the network device is further caused to:
determine a transmission priority of the tactile data flow and a transmission priority of the at least one first data flow; and
synchronize the transmission priority of the tactile data flow and the transmission priority of the at least one first data flow.

14. The network device according to claim 13, wherein to determine the transmission priority of the tactile data flow and the transmission priority of the at least one first data flow, the network device is caused to:
determine products of channel quality coefficients and quality of service coefficients that correspond to the tactile data flow and the at least one first data flow as first parameters; and
determine ratios of the first parameters to a historical average rate as the transmission priority corresponding to the tactile data flow and the transmission priority corresponding to the at least one first data flow.

15. The network device according to claim 14, wherein the network device is further caused to:
send the tactile data flow and the at least one first data flow to the user-side device.

16. The network device according to claim 9, wherein the synchronization identifier comprises a frame number of a tactile frame corresponding to tactile data and a common air interface transmission time interval number.

17. A machine-side device, comprising:
at least one processor; and
one or more memories including computer instructions that, when executed by the at least one processor, cause the machine-side device to:
obtain a first signal comprising tactile data and at least one piece of first data;
generate a tactile data flow and at least one first data flow based on the first signal, wherein the tactile data flow and the at least one first data flow comprise a synchronization identifier; and
send the tactile data flow and the at least one first data flow to a network device.

18. The machine-side device according to claim 17, wherein to generate the tactile data flow and the at least one first data flowbased on the first signal, the machine-side device is caused to:
generate the tactile data flow based on the tactile data; and
generate the at least one first data flow based on the at least one piece of first data.

19. The machine-side device according to claim 18, wherein the machine-side device is further caused to:
before obtaining the first signal, send data flow parameter information to the network device, wherein the data flow parameter information is parameter information of data flows transmitted between the network device and the machine-side device and between the network device and a user-side device, and the data flow parameter information comprises a quality of service coefficient, a synchronization time reference, and a sensor frequency.

20. The machine-side device according to claim 17, wherein the synchronization identifier comprises a frame number of a tactile frame to tactile data and a common air interface transmission time interval number.
